(19) United States
(12) Patent Application Publication
(10) Pub. No.: US 2005/0068016 A1
(43) Pub. Date: Mar. 31, 2005

(54) Power supply device

(76) Inventor: Tsung-Yung Hung, Taipei (TW)

Correspondence Address: SUPREME PATENT SERVICES, POST OFFICE BOX 2339, SARATOGA, CA, 95070, US

(21) Appl. No.: 10/672,352

(22) Filed: Sep. 27, 2003

(51) Int. Cl. G05F 1/40

(52) U.S. Cl. 323/282

(57) ABSTRACT

A power supply device disposed in an electronic device having a main power supply includes a voltage converting unit for converting the voltage from the main power supply, a power controlling unit for controlling the current from the converting unit, and a USB interface unit for providing the electric power from the main power supply to peripheral units.

### FIELD OF THE INVENTION

The present invention relates to a power supply device that supplies electric power to peripheral units of an electronic device while the main power is switched off.

### BACKGROUND OF THE INVENTION

A conventional electronic device, especially for those having multiple functions in one unit generally includes a main power supply that provides electric power to the parts so as to maintain functional operation of these parts. Once the main power supply is shut down, all the power for the interfaces is shout down. This does not meet the requirement for some device that needs power supplied to the peripheral units while the main power is switched off.

Therefore, it is desired to have a power supply device that provides power to the peripheral units while the main power is shut down.

### SUMMARY OF THE INVENTION

In accordance with an aspect of the present invention, there is provided a power supply device connected to an electronic device having a main power supply. The power supply device comprises a voltage-converting unit for converting a voltage output from the main power supply of the electronic device according to a converting command so as to generate a voltage status. A power-controlling unit controls an output from the voltage-converting unit to be a status of power supply by a control command when the electronic device is shut down. A USB (Universal Serial Bus) interface unit is connected to a peripheral unit and outputs electric power from the main power supply to the peripheral unit based on the status of the power supply.

The present invention will become more obvious from the following description when taken in connection with the accompanying drawings, which show, for purposes of illustration only, a preferred embodiment in accordance with the present invention.

### BRIEF DESCRIPTION OF THE DRAWINGS

FIG. 1 shows an arrangement of a power supply device, a main power supply and peripheral units in accordance with the present invention;

FIG. 2 shows a block diagram of the power supply device of the present invention;

FIG. 3 shows another embodiment of the power supply device of the present invention; and

FIG. 4 shows the display on a liquid crystal display panel of the power supply device of the present invention.

### DETAILED DESCRIPTION OF THE PREFERRED EMBODIMENT

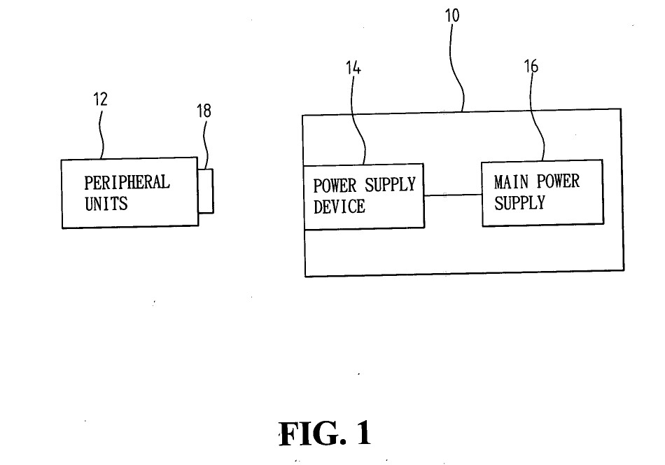

Referring to FIG. 1, a power supply device 16 of the present invention is used for an electronic device 10, such as a personal computer and a laptop computer. When the electronic device 10 is in a shutdown status, the power supply device 14 provides electric power to peripheral units 12 such as mobile phones, PDAs (Personal Digital Assistants), or CD player, from the main power supply 16. The main power supply device 16 can be an AC/DC converter, an AC battery or both.

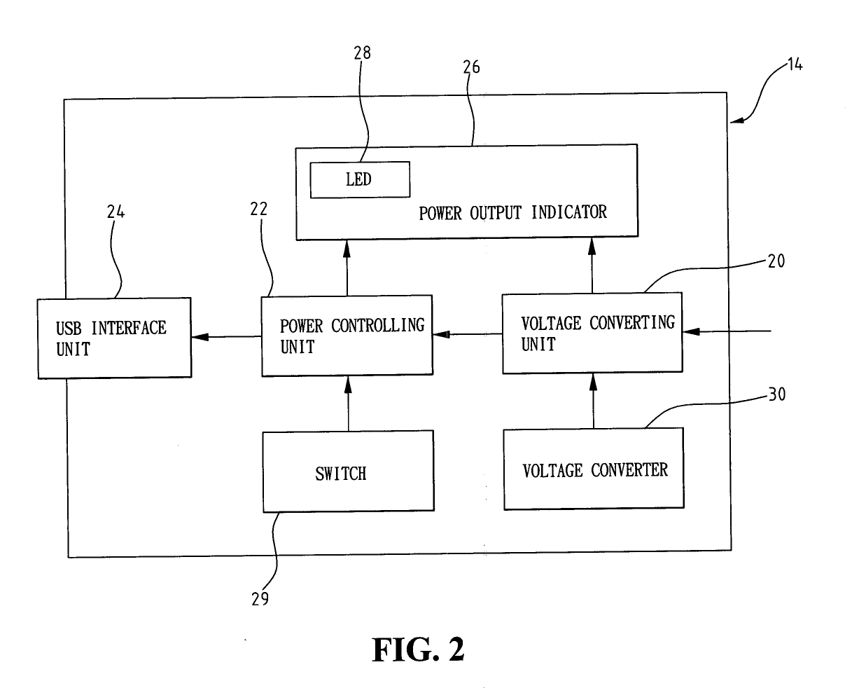

Referring to FIG. 2, the power supply device 14 comprises a voltage-converting unit 20, a power-controlling unit 22, a UBS (Universal Serial Bus) interfaces unit 24, a voltage converter 30, a switch 29, and a power output indicator 26. The voltage-converting unit 20 converts the voltage from the main power supply 16 of the electronic device 10 according to a converting command so as to generate a voltage status that is output from the power supply device 14. The power controlling unit 22 controls the output from the voltage-converting unit 20 to be a status of power supply by a control command when the electronic device 10 is shut down. The USB interface unit 24 is connected to a peripheral unit 12 and outputs the electric power from the main power supply 16 to the peripheral unit 12 based on the status of the power supply as mentioned above. The voltage converter 30 gives a command to the voltage-converting unit 20 and affects the voltage status. The command from the voltage converter 30 is designed for the user to decide the voltage that is converted from the power received by the electronic device 10 via the voltage converter 30. The switch 29 is used to submit commands to the power-controlling unit 22. The power output indicator 26 indicates the status of the power via the USB interface unit 24 based on the status of supply and the voltage status.

The power controlling unit 22 makes the electronic device 10 supplied the electric power from the main power supply 16 by diodes, power MOS or transistors. Nevertheless, if the user submits the control command to let the function of the power controlling unit 22 fail by operating the switch 29, no power is supplied from the main power supply 16 after the electronic device 10 is shut down. Therefore, the switch 29 provides an option for the user to decide whether or not the power is output from the USB interface unit when the electronic device 10 is shut down.

The power supply device of the present invention allows the user to optionally get electric power from the main power supply 16 while the electronic device 10 is shut down.

In order to inform the user whether or not the power-controlling unit 22 is in function by operating the switch 29, the light-emitting diode (LED) 28 on the power output indicator 26 shows the status. When the LED 28 of the power output indicator 26 lights up, it means that the peripheral units 12 are supplied with power via the USB interface unit 24 while the electronic device 10 is shut down. On the other hand, if the LED 28 of the power output indicator 26 does not light up, it means that the peripheral units 12 are not supplied with power via the USB interface unit 24 while the electronic device 10 is shut down.

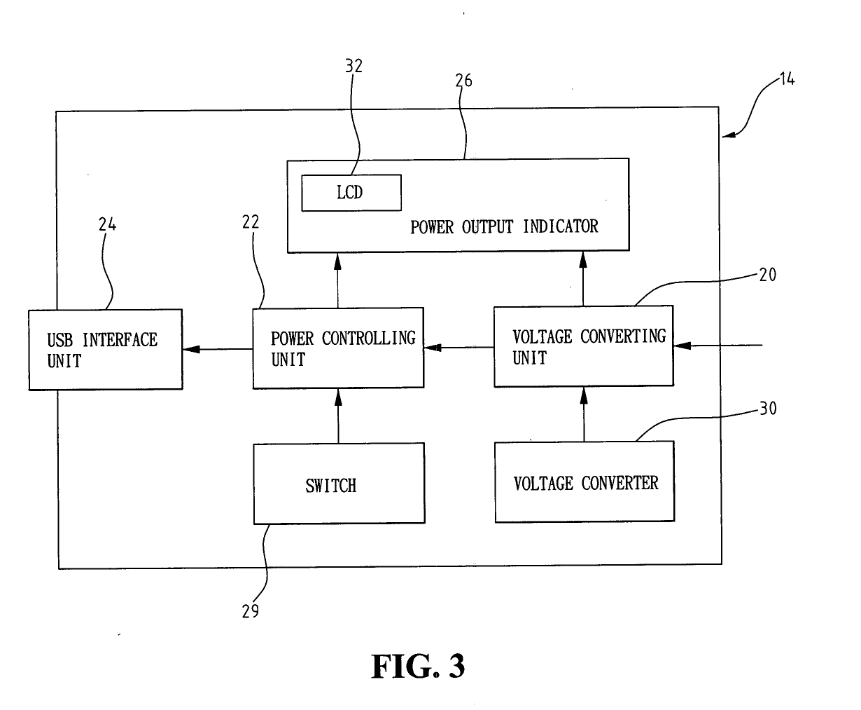

Referring to FIG. 3, which shows another embodiment of the present invention, wherein the a liquid crystal display (LCD) panel 32 is replaced with the LED 28 as shown in FIG. 2.

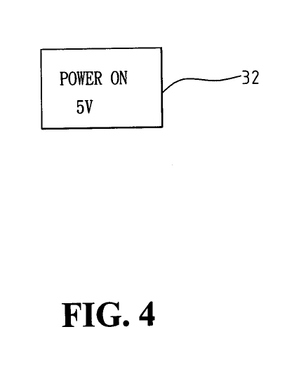

FIG. 4 shows the LCD panel that displays words that are the proper way to show the status of supply and voltage. In FIG. 4, “POWER ON” shows the status of supply and the voltage status is shown by “5V”.

While we have shown and described the embodiment in accordance with the present invention, it should be clear to those skilled in the art that further embodiments may be made without departing from the scope of the present invention.

1. A power supply device disposed in an electronic device having a main power supply, the power supply device comprising:
a voltage converting unit, for converting a voltage adapted to be output from the main power supply of the electronic device according to a converting command so as to generate a voltage status;
a power controlling unit, for controlling an output from the voltage converting unit to be a status of power supply by a control command when the electronic device is adapted to be shut down; and
a USB interface unit for connection to a peripheral unit and adapted to output electric power from the main power supply to the peripheral unit based on the status of the power supply.

2. The power supply device as claimed in claim 1 further comprising a voltage converter that gives the converting command to the voltage-converting unit.

3. The power supply device as claimed in claim 1 further comprising a switch that submits the control commands to the power-controlling unit.

4. The power supply device as claimed in claim 1 further comprising a power output indicator indicating the status of the power via the USB interface unit based on the status of power supply and the voltage status.

5. The power supply device as claimed in claim 2 further comprising an LED on the power output indicator and power being adapted to be supplied to the peripheral units via the USB interface unit while the electronic device is shut down.

6. The power supply device as claimed in claim 2 further comprising an LCD panel that displays by words to show the status of power supply and the voltage status.
